(19) United States
(12) Patent Application Publication
(10) Pub. No.: US 2015/0142533 A1
(43) Pub. Date: May 21, 2015

(54) METHOD FOR LOCATION-BASED VEHICLE PARKING MANAGEMENT AND PARKING-FEE PAYMENT ENFORCEMENT

(71) Applicant: Ofir Shalev, Singapore (SG)

(72) Inventor: Ofir Shalev, Singapore (SG)

(21) Appl. No.: 14/082,634

(22) Filed: Nov. 18, 2013

(51) Int. Cl. G06Q 50/30; G06Q 10/00; G06Q 20/14

(52) U.S. Cl. CPC G06Q 50/30; G06Q 20/145; G06Q 10/00
USPC 705/13

(57) ABSTRACT

A method for location-based vehicles parking management and parking-fee payment enforcement is disclosed. The method utilizes mobile devices capable of identifying the current location of the devices and other descriptions of how the devices are placed using various sensor data, and transmitting this information via wireless communication to a parking management application, that supports numerous municipalities and allows a user-friendly access and management via one of more user-friendly portals. The method further includes parking enforcement based on a current location and how an enforcement device is placed and one or more verification methods. Other preferred embodiments of the parking enforcement method are disclosed such as a motorbike based system, an augmented reality based system and an aerial system.

### CROSS-REFERENCE TO RELATED APPLICATIONS

The present application claims priority to U.S. Provisional Patent Application No. 61/727,721, filed on Nov. 18, 2012, entitled “ System method and a computer program product for location-based vehicles parking management and parking-fee payment enforcement” which is incorporated by reference in its entirety all having by same inventor.

### BACKGROUND

There are many different types of parking systems that currently exist, such as coin-parking meters, pre-paid parking coupons and the like, all of which have different disadvantages. As an example, the pre-paid parking coupons do not require any special infrastructure, however a municipal parking official must approach each vehicle to read the parking cards and validate that the vehicle is validly parked. Other parking systems requires various meters, such as coin operated meters, but these meters requires a municipality to install them near every parking lot, wherein both the initial setup and maintenance costs may be quite high, especially for those municipalities that own and manage a large number of parking lots at different locations.

Other systems include radio frequency identification devices (hereinafter referred to as “RFID”) that allow the identification of the vehicle but require special and dedicated devices or readers. Other systems allow for payment of the parking fees using mobile devices, but don't offer an efficient way for the municipal parking official to validate that the vehicle is validly parked.

The prior art illustrates the required dedicated and often expensive hardware and physical infrastructure such as radio frequency identification (RFID) tags, RFID readers, coin-operated meters, electronic meters and different types of sensors installed in proximity to the parking lots to collect parking revenue and enforceability. Therefore, a need exists to limit both the cost and complexity of having additional devices or dedicated hardware or physical infrastructure in proximity to the parking lots or near the vehicle. The subject invention solves this problem in a new a unique method utilizing common commercial mobile phones or smart phones that a user is typically carrying for standard communication.

### SUMMARY

A method for location-based vehicles parking management and parking-fee payment enforcement is disclosed. The method utilizes mobile devices capable of identifying the current location of the devices and other descriptions of how the devices are placed using various sensor data, and transmitting this information via wireless communication to a parking management application, that supports numerous municipalities and allows a user-friendly access and management via one of more user-friendly portals. The method further includes parking enforcement based on a current location and how an enforcement device is placed and one or more verification methods. Other preferred embodiments of the parking enforcement method are disclosed such as a motorbike based system, an augmented reality based system and an aerial system.

### BRIEF DESCRIPTION OF THE DRAWINGS

For a clearer understanding of the invention and to see how the same may be carried out in practice, a preferred embodiment will now be described, by way of non-limiting example only, with reference to the accompanying drawing, in which:

FIG. 1 is a block-diagram of the location-based vehicles parking management and parking-fee payment enforcement system;

FIG. 2 illustrates a method of creating a new portal;

FIG. 3 illustrates a method for setting a portal;

FIG. 4 illustrates a method to start a parking session;

FIG. 5 illustrates a method to stop a parking session;

FIG. 6 illustrates a method to check for parking violation using unique identification token;

FIG. 7 illustrates a location-based method to check for parking violations;

FIG. 8 illustrates a motorbike based parking-fee payment enforcement system according to an embodiment of the disclosure;

FIG. 9 illustrates an augmented reality parking-fee payment enforcement system according to an embodiment of the disclosure; and

FIG. 10 illustrates an aerial parking-fee payment enforcement system according to an embodiment of the disclosure.

### DETAILED DESCRIPTION

It should be clear at the outset that although the implementation of one possible embodiment of the disclosure is illustrated below, the system may be implemented using any number of techniques.

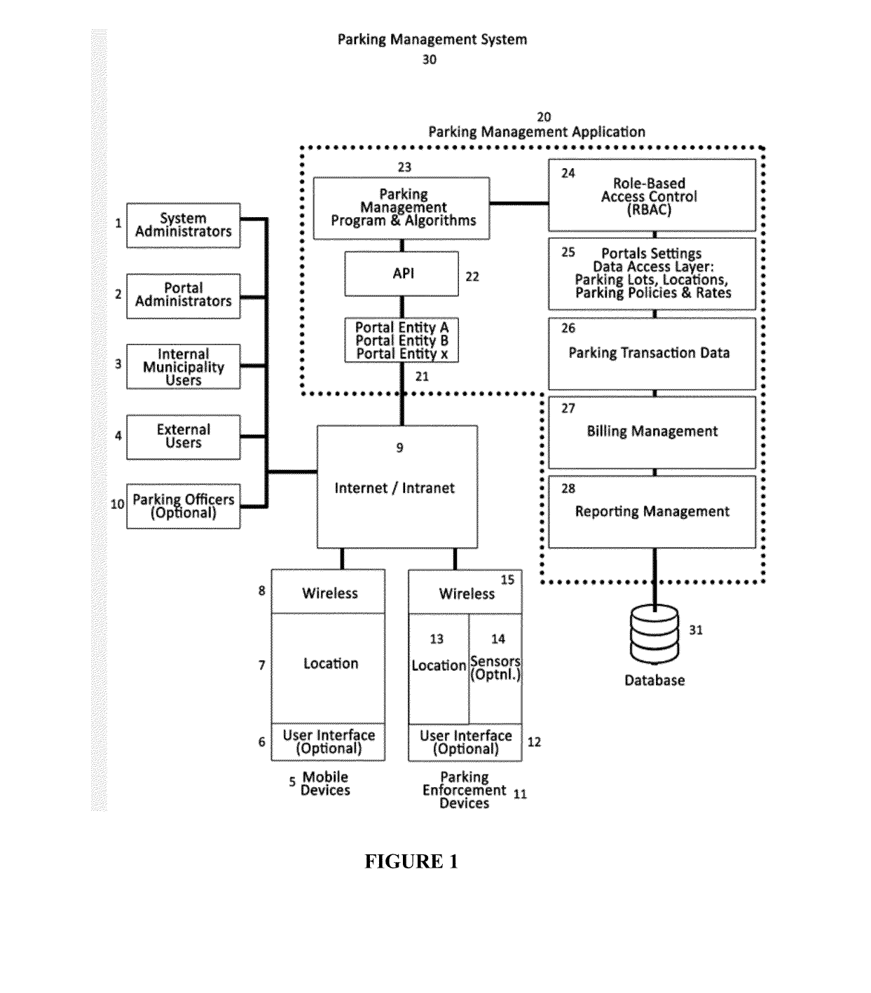

Referring now to FIG. 1, there is shown a system 30 for location-based vehicles parking management and parking-fee payment enforcement. The same system 30 may support numerous entities. These entities would typically be a country, a city, a retail center, hotel or some other municipality that collects fees by allowing vehicles to park on their property. The term “municipality” refers to any such entity that enforces and collects parking fees.

Turning now to FIG. 1, mobile device 5 may be used by external user 4 to start the parking transaction once the vehicle has reached a parking lot and to stop it later once the vehicle is about to leave the parking lot, and to interact with a Parking management application using user interface 6 or any relevant method available such as voice recognition, gesture recognition and more. It should be understood that the mobile device 5 might be any easily portable device that is capable to connect via wireless communication 8 to the parking management application 20, is able to identify the current location of the mobile device 5 using various sensor data 7 and is able to execute a computer program and optionally allows the user to interact with the computer program using the User Interface 6. In one preferred embodiment, the sensor may be a global positioning system (GPS). The mobile device 5 may be a mobile phone, a portable computer, a laptop, a navigation system and any other similar device.

In yet another preferred embodiment, a parking enforcement device 11 may be used by a parking officer 10 to efficiently check for parking violations, and to interact with the parking management application 20 using user interface 12. The parking enforcement device 11 might be any easily portable device that is capable to connect via wireless communication 15 to the parking management application 20, can optionally identify the current location of the parking enforcement device 11 using various sensor data 13, can optionally identify other descriptions of how the parking enforcement device 11 is placed in space using additional sensor data 14, and is able to execute a computer program and optionally allows the user to interact with the computer program using the user interface 12. In yet still another preferred embodiment the location sensor 13 may be a global positioning system (GPS), and the additional sensors can be an accelerometer (not shown) for detecting the orientation of the device, or a compass for detecting the device's orientation relative to a magnetic field and more. As stated above, the parking enforcement device 11 may be a mobile phone, a portable computer, a laptop, a navigation system and/or any other similar device.

A key differentiator from other inventions in this field that require dedicated and often expansive hardware and physical infrastructure such as radio frequency identification (RFID) tags, RFID readers, coin-operated meters, electronic meters and different types of sensors installed in proximity to the Parking Lots, is that in the current system 30 both the mobile device 5 and parking enforcement device 11 may be any common commercial mobile phone or smart phone that the external user 4 may be carrying anyway as a way of communication, and with this invention there is no need for any additional devices or dedicated hardware or physical infrastructure in proximity to the Parking Lots or near the vehicle.

Referring once again to FIG. 1, the system 30 is composed of one or more client-side devices including the mobile devices 5, the parking enforcement devices 11 and any software such as web browsers used by system administrators 1, portal administrators 2, internal municipal users 3, external users 4, parking officers 10 and any other users and roles accessing the various portals. The server side, hosted on physical servers, virtual servers or on the cloud or any other scalable infrastructure, includes the parking management application 20 and one or more database servers 31 storing the application setup data, the application transactional data and any other persistent data used by the parking management application 20. In a typical embodiment some of the common components in the parking management application 20 are role-based access control (RBAC) 24, portal settings data access layer 25 that provides simplified access to portals 21 data stored in persistent storage 31, parking transactions data access layer 26 that provides simplified access to the parking transactions, billing management 27 that supports various billing methods including but not limited to direct billing, credit cards and debit cards, bank transfer, PayPal, and reporting management 28 that generates different reports including but not limited to parking lots utilization reports such as how many vehicles parked at specific parking lots over a period of time, various financial reports such as overall parking fees over a period of time and more. The parking management program its associated algorithms 23 contains the sequence of instructions written to perform the different tasks triggered by the application program interface (API) 22 and also includes the different algorithms required for the program to operate, such as algorithms to convert from one geographic coordinate system to another geographic coordinate system, algorithms to calculate the closest parking lot to a specific location, algorithms to find the parking lots accessible from a specific location and any other algorithms. The application programming interface (API) 22 is used as an interface to the parking management program and algorithms 23 and may include specifications for routines, data structures, object classes, and variables. The portals 21 interact with the parking management program and algorithms 23 via the application programming interface (API) 21.

Each municipality might operate and manage different parking lots at different locations, support different parking policies and parking rates, support different payments options and might occasionally update these policies and settings. The municipality might also generate timely reports including payment reports, parking lots utilization reports and other reports. Each municipality might access and manage all of the above policies, locations, rates, different options and data feeds via one more user-friendly portals 21 accessible via a secured and encrypted communication over the internet or the intranet 9 where the different settings described above are accessed via the portals settings data access layer 25. The access to the application 20 and various Portals 21 are controlled by the role-based access control (RBAC) 24 restricting system access to authorized users. Within the system 30, different roles include system administrators 1, portals administrators 2, internal municipality users 3, external users 4, parking officers 10 and any other roles, are created for various job functions. The permissions to perform certain operations may be assigned to specific roles, where zero or more users are assigned to specific roles using a user-interface component embedded in the portals 21.

Turning once again to FIG. 1, There is shown still yet another embodiment including multiple different roles accessing the system 30, where system administrators 1 might control and manage different global settings of the system 30, create, delete and suspend specific portals 21, generate global reports aggregating information across multiple municipalities, set and modify parking policies and parking rates and set and modify other relevant global settings. Portal administrators 2 might control and manage different settings of the system 30 specific to one or more municipalities and one or more portals, set and update parking lot locations, set and modify different parking policies and parking rates, set and modify different payment options and set and modify any other relevant settings . Typically, portal administrators 2 might not have the permissions to perform the same operations as system administrators.

Internal municipality users 3 may be responsible to manage the on-going operation of the parking management system 30, such as updating the location of new parking lots, updating parking policies, query specific billing or parking violations details that may be used as part of a call center operation, generating timely billing and other reports and more. The internal municipality users may include different roles as part, for example users from the finance department might have the permission to generate billing reports but might not have the permissions to update parking lot locations, call center users might have the permission to query details regarding a specific vehicle that parked at a specific date in a specific parking lot, but might not have the permission to generate a financial report. The internal municipality users interacts with the parking management system 20 using the portals 21.

The external users 4 may include the people that park their vehicles at the parking lots that belong to the municipality and pay the parking fees accordingly. For example, for the case that a city is using the parking management system 30, the external users 4 may be the residents of that city that park their vehicles in parking lots controlled and managed by the same city, and also other people from other cities or countries that park their vehicles at these parking lots. The external users 4 may interact with the Parking management system 30 via the Portals 21 to perform various operations, including but not limited to update their personal details, add vehicles to their personal records or remove vehicles from their personal records, update payment details, view an online statement of the parking fees paid and more.

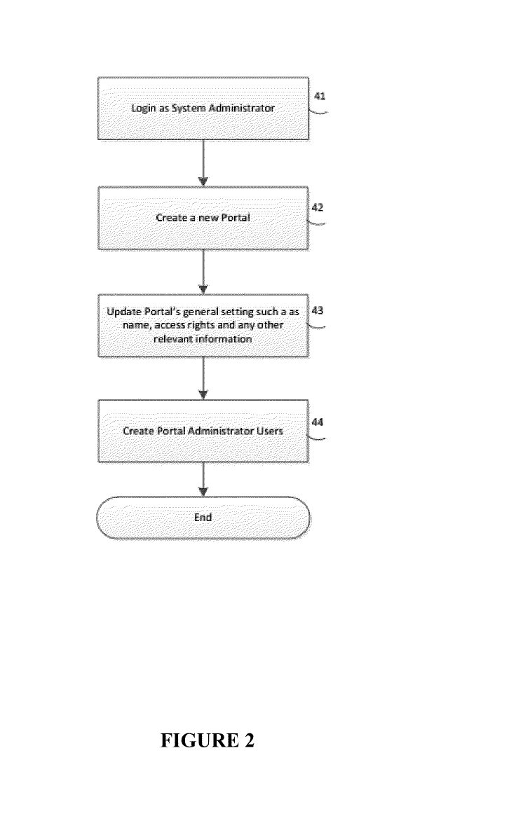

FIG. 2 shows a method where a system administrator creates a new portal. Once the system administrator logs in to the system 41, she/he may select the option of creating a new portal 42 and update different general settings 43 including the name of the portal set the access rights and any other relevant information. The system administrator might also create one or more portal administrator users 2. The portal may be created by an external user 4 as well, for the cases where the system administrator enables the self-service portal creation.

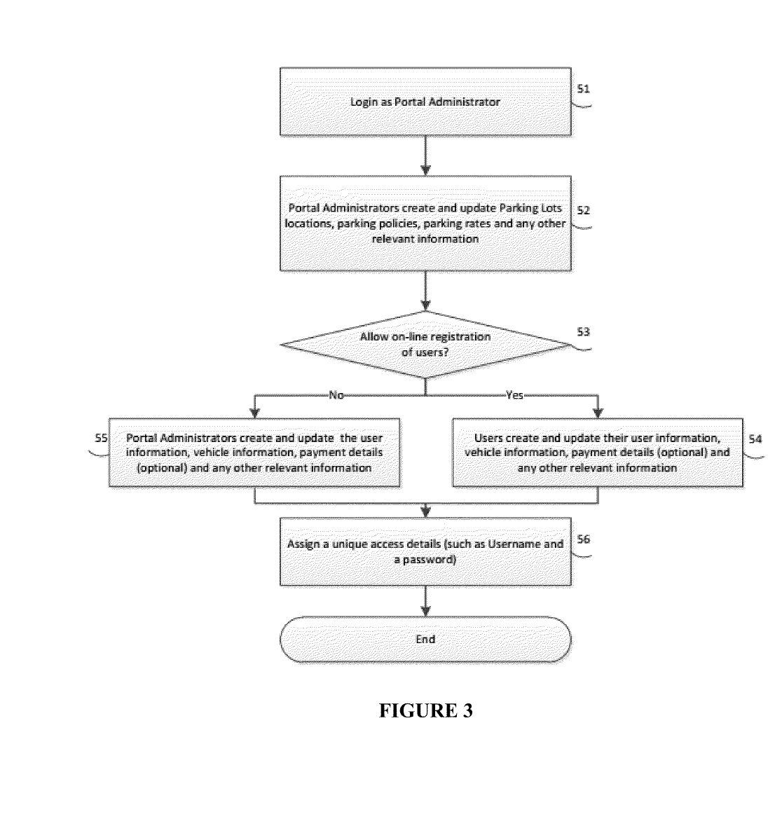

Once a new portal has been created, FIG. 3 shows a method where portal administrators login to the system 51 to update and manage different settings of the portal 21. The location of the Parking Lots may be specified using a geographic location system, where in one embodiment the coordinate system may be latitude, longitude and elevation. The portal administrator may also define different parking policies and different parking rates. The parking policies may vary by location so as an example parking at a central business district (CBD) might be limited to two hours whereas parking at other districts might not be so limited. The parking rates might vary by location so as an example parking at the central business district (CBD) might be more expensive than parking at other districts. Parking policies might vary by vehicle type, so heavy vehicles might not be allowed to park in certain parking lots whereas motorcycles might be allowed to park at these same parking lots. Also, parking rates might vary by vehicle type, for example parking fees for a motorcycle might be cheaper than parking fees for a heavy vehicle. Parking fees might also vary depending on the time, so as an example parking fees at night might after certain hours be different than parking fees by day. Also, parking at certain days of the week like weekend days, or certain days of the month or certain days of the year like public holidays might have different rates or different polices than other days. These and other settings may be set by the portal administrators based on the specific rules, polices and rates applicable to the specific municipality.

Turning back to Back to FIG. 3. the portal administrator 2 might allow the on-line registration of external users 54 where external users 4 create and update their user information such as first name, last name, home address, phone number, might update various billing information such as a credit card number, PayPal account and more, might update various vehicle details like vehicle type, manufacturer, license plate number and any additional information required at later stages of the process. The portal administrator 2 might not allow the on-line registration of external users 55 and may create, update or upload the same details. For both cases, each external user 4 is assigned with unique access details, such as username and password, which is used by the role-based access control (RBAC) 24 once the user will access the parking management system 30.

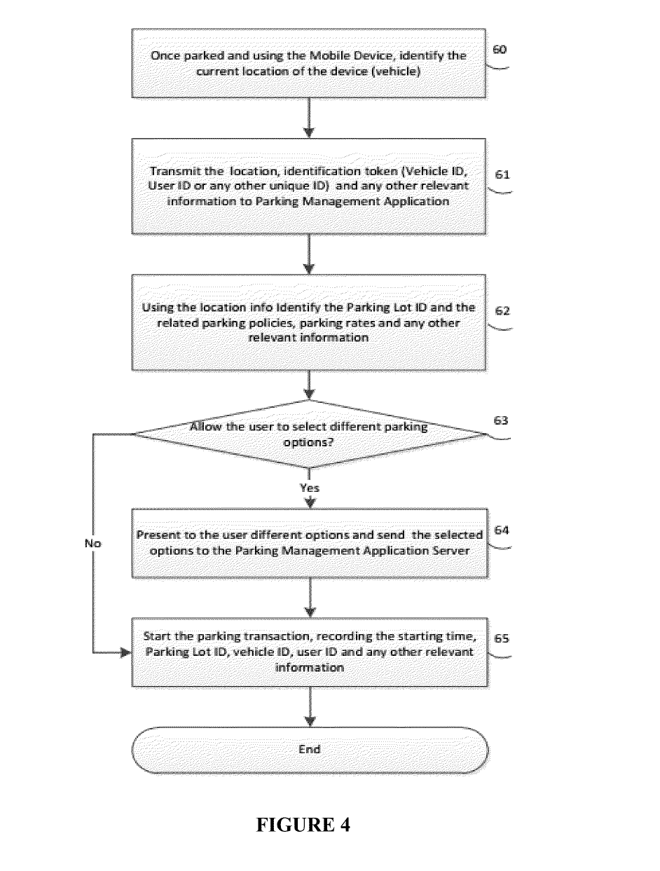

FIG. 4 shows a method where the external user 4 parks his vehicle at one of the parking lots managed by the parking management system 30 and starts a parking transaction 60. The external user 4 might start the parking transaction manually by interacting with the user interface 6 or alternatively mobile device 5 might periodically identify a location 7 to detect when the vehicle has stopped and start the parking transaction automatically. Once the mobile device 5 identifies the current location of the device and the vehicle, it transmits 61 this location and the unique identification token that identifies this specific vehicle and any additional relevant information, via the wireless component 8 to the parking management application 20. In yet another preferred embodiment a unique identification token might be a unique vehicle ID associated with that user and extracted from the information stored in database 31. For those cases when a user registers multiple vehicles, the mobile device 5 might ask the user, via user interface 6, to select the vehicle to start the parking transaction. The information sent from the mobile device 5 to the parking management information 20 is used by the parking management program and algorithms 23 and the various databases 31 to identify the Parking lot ID 62 and any related information such as the parking policies, the parking rates and more associated with that the specific Parking Lot.

In yet still another preferred embodiment where there are multiple parking options the user might select from multiple choices 63 presented to him. As an example, once the Parking Lot ID was identified 62 and given the current date and time, vehicle type and any other relevant information, the system might identify two or more parking policies, for example night parking paying one-time parking fee of $5 parking from 22:00 to 6:00 the day after, or another option of paying 50 cents per hour as long the parking transaction is on. The user might be presented with these different options 64 via the user interface 6 where the user might select his preferred option based on the expected parking duration and any other considerations. Alternatively, the parking management application might select the optimal option automatically using the parking management program and algorithms 23 and any other relevant data. Either way, the parking transaction is started 65 where the relevant information such as starting time, unique identification token, vehicle ID, user ID and any other information is stored in the databases 31.

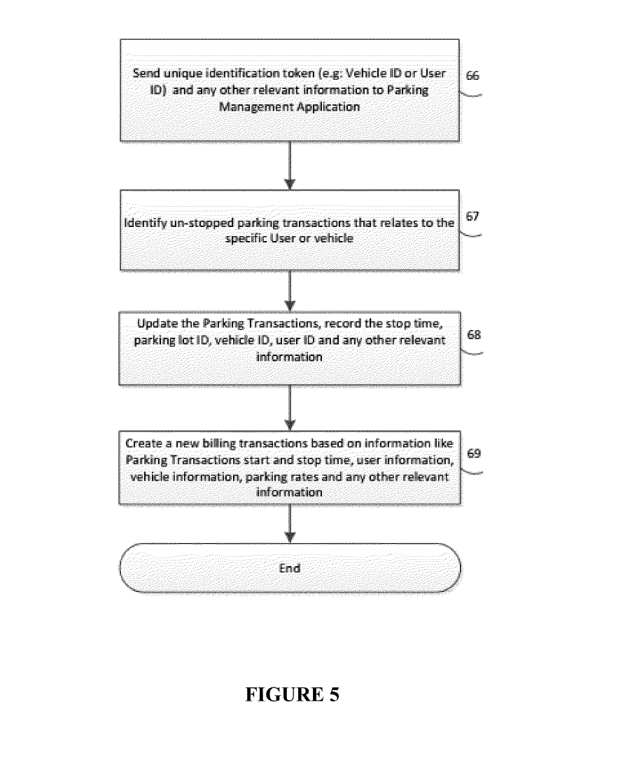

FIG. 5 shows a method where the External User 4 stops the parking transaction just before leaving the parking lot. Using the mobile device 5 the unique identification token is sent including any additional information 66 to the parking management application 20 where the un-stopped parking transactions are identified 67 and updated in the database 31 by the parking management program and algorithms 23 to be marked as stopped transaction 68. A billing transaction might be created 69 based on the parking start and stop time, user information, vehicle information, parking rates and any other relevant information.

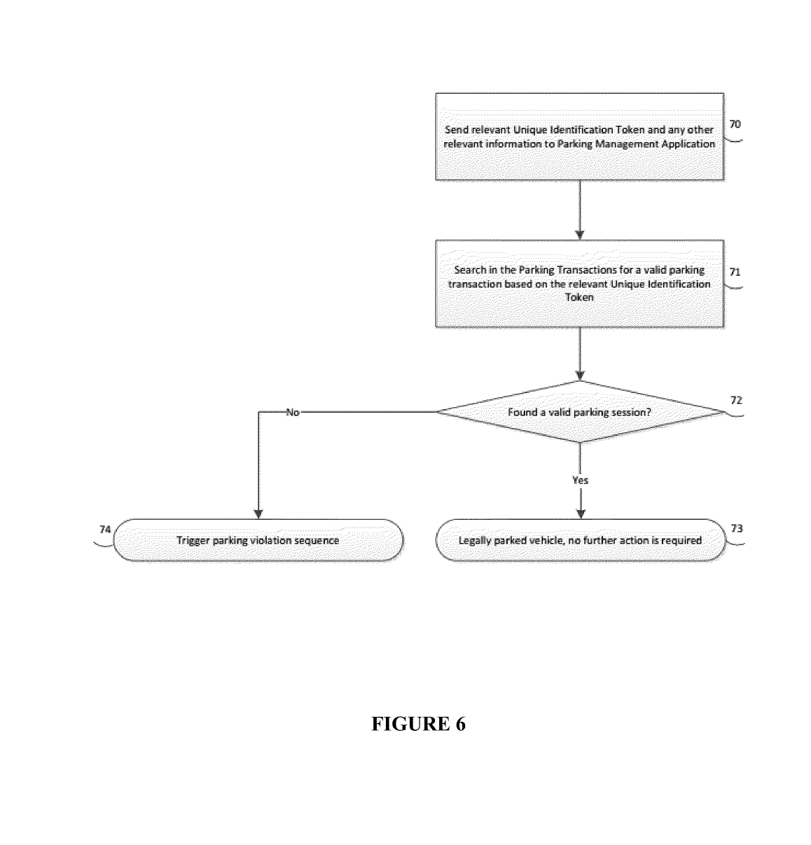

Referring to FIG. 6, the parking officer checks for parking violations using the parking enforcement device 11, where the sequence starts 70 by sending the unique identification token such as license plate number and any other relevant information to the parking management application 20, where the parking management program and algorithms searches 71 in the database 31 for the parking transaction record for the specific vehicle represented by the unique identification token and checks whether there is a valid parking transaction 72. If a valid parking transaction is found 73 no further action is required. Otherwise, a parking violation sequence might be triggered 73. As an example and turning back to FIG. 4, if a user started a parking transaction for a vehicle with a license plate number AB123456, once the parking transaction was started and recorded in the database 31, if a parking officer using the parking enforcement device 11 sends 70 the Unique Identification Token AB123456 the system may identify that a valid parking transaction was started for this vehicle so no further action is required.

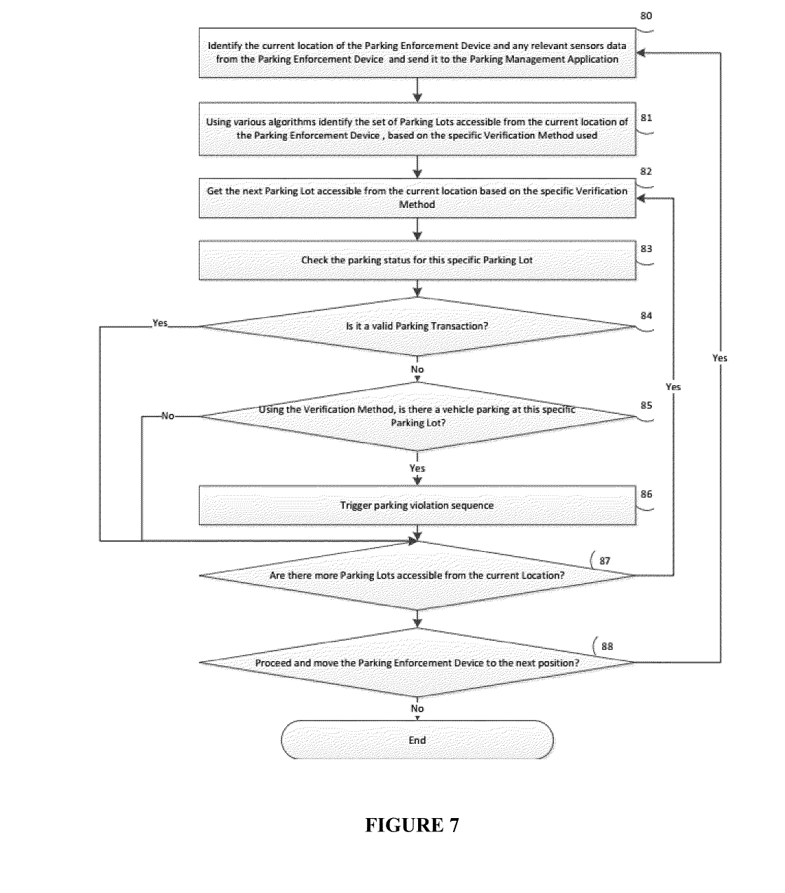

Checking for each vehicle for the existence of a valid parking transaction might be a resource intensive process, where the parking officer 10 might need to approach each vehicle and apply the method described in FIG. 6 for each vehicle. Alternatively, FIG. 7 describes a more efficient method using the location of the parking enforcement device 11 and using one or more verification methods. A verification method is defined as a method, either human-based or automated, that given a specific parking lot decides whether there is a vehicle currently parking at that specific parking lot. An example of a human-based visual verification process is a person that looks at the specific parking lot and sees whether a vehicle is parking there or not. Referring once again to FIG. 7, the parking enforcement device 14 identifies the location 80 and any other relevant sensors data from the parking enforcement device 14 and sends it to the parking management application 20. Based on one or more verification methods, and the location of the parking lots stored in the database 31 and accessible via the portals settings data access layer 25, and the various sensors data sent 80 and any other relevant information, the parking management program and algorithms 23 calculates the set of parking lots accessible from the current location of the parking enforcement device 81. Without any loss of generality and to improve the performance of the system some of these algorithms may be executed on the client device as well where data can be cached to the client side as well. Assuming one or more accessible parking lots were found, the system gets the next parking lot from the set accessible parking lots 82 and using the parking transaction data access layer checks whether the database 31 contains a valid unstopped parking transaction for this specific parking lot 83, and if the result 84 is positive then the algorithm can proceed and check the status of the next parking lot 82. If on the other hand the result 84 is negative, meaning that there is no valid parking transaction assigned to that specific parking lot, a verification method is applied 85 on this specific parking lot to find whether there is a vehicle parking at that specific parking lot, and if the result is no, meaning there is no vehicle parking at that specific parking lot then the algorithm may proceed and check the status of the next parking lot 82. If on the other hand the result of the verification method 85 is positive, meaning there is a vehicle parking at this specific parking lot and although it was found earlier 84 there is no valid parking transaction assigned to that parking lot, it means the vehicle is parking illegally and one can trigger the parking violation sequence, including issuing parking fine. If no more parking lots are available from the current location 88 the parking enforcement device may be moved to the next physical position 89 and the process can start 80 for the new location.

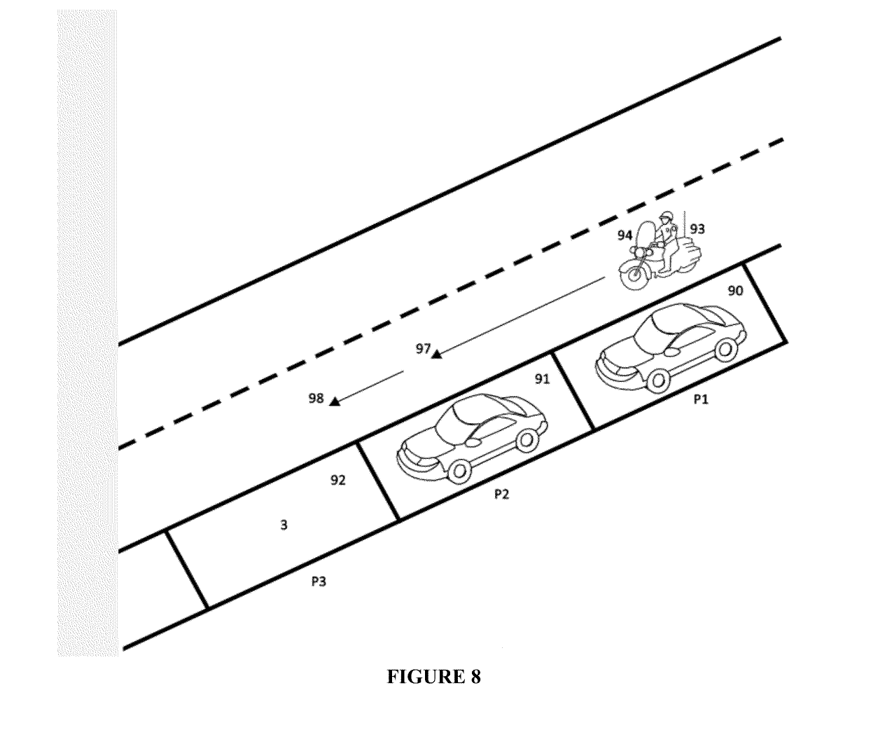

FIG. 8 shows an embodiment of the method described in FIG. 7, where the parking officer is riding a motorbike 93 where the parking enforcement device may be mounted 94 to a motorbike. As an example, the verification method will be a visual inspection done by the parking officer looking to his left and we will assume that there are three parking lots defined with their location as part of the portal settings, parking lot P1 90, parking lot P2 91 and parking lot P3 92 where the first vehicle 95 is parking legally in P1, meaning there is a valid unstopped parking transaction associated with this parking lot. The second vehicle 96 is parking illegally in P2, meaning there is no valid unstopped parking transaction associated with this parking lot. Back to the method described in FIG. 7, the parking enforcement device 94 identifies the current location of the motorbike and the parking officer 93 and sends the current location 80 to the parking management application 20. As the verification method is based on the visual inspection to the left of the parking officer 93, the parking management program and algorithms identifies P1 90 as the parking lot to the left of the parking enforcement device 94, within predefined proximity to the device 94 and within the visual line-of-sight. Checking the parking status 83 for P1 will result in a valid parking transaction 84 so no visual inspection is needed by the parking officer, and as there are no more parking lots accessible from the current location 87 the process will restart 88 once the parking enforcement device will move near next parking lot, P2 91 to the new location 97. Similarly, the parking enforcement device 94 identifies the current location of the motorbike and the parking officer 93 and sends the current location 80 to the parking management application 20. As the verification method is based on the visual inspection to the left of the parking officer 93, the parking management program and algorithms identifies parking lot P2 91 as the parking lot to the left of the parking enforcement device 94, within predefined proximity to the device 94 and within the visual line-of-sight. Checking the parking status 83 for P2 will result in a non-valid parking transaction 85 that may trigger a visual notification on the user interface 12 or a specific sound generated by the parking enforcement device, notifying the parking officer that there is no valid parking transaction associated with P2 91. Once the parking officer applies the verification method 85 and looks left he sees that there is a vehicle parking at P2 so the parking officer triggers the parking violation sequence 86, that might include issuing a parking ticket. As there are no more parking lots accessible from the current location 87 the process will restart 88 once the Parking Enforcement Device will move to the new location 98 near the next Parking Lot, P3 92. Similarly the parking enforcement device 94 identifies the current location of the motorbike and the parking officer 93 and sends the current location 80 to the parking management application 20. As the verification method is based on the visual inspection to the left of the parking officer 93, the parking management program and algorithms identifies P3 92 as the Parking Lot to the left of the parking enforcement device 94, within predefined proximity to the device 94 and within the visual line-of-sight. Checking the parking status 83 for Parking Lot P3 will result in a non-valid parking transaction 85 that may trigger a visual notification on the user interface 12 or a specific sound generated by the parking enforcement device, notifying the parking officer that there is no valid parking transaction associated with parking lot P3 91. Once the parking officer applies the verification method 85 and looks left he sees that there is no vehicle parking at P3 so obviously no need to trigger the parking violation sequence.

For the common cases where the majority of the vehicles parks legally, it is clear that the method described is FIG. 7 and demonstrated in FIG. 8 is more efficient than the method described in FIG. 6 and other similar methods, as the method described in FIG. 7 allows the parking officer to apply a quick verification method for the legally parked vehicles.

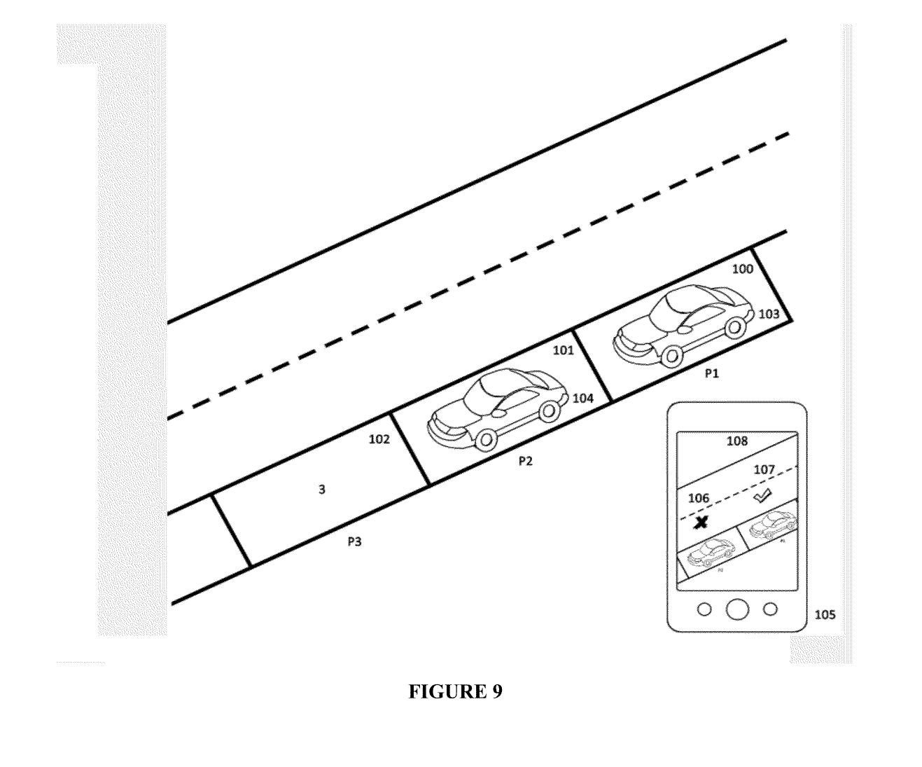

FIG. 9 shows another embodiment of the method described in FIG. 7 where the parking officer uses the parking enforcement device 105 to view a live real-world environment where the parking status is augmented by computer-generated sensory input such as sound, video, graphics or location data, often referred to as augmented reality. Back to method described in FIG. 7 the parking enforcement device may include sensors such as a global positioning system (GPS) 13 or using other commercially available location based services, such as cell tower triangulation signal from or WiFi networks, and additional sensors such as accelerometer detecting the orientation of the device, compass detecting the device's orientation relative to that magnetic field and more 14 identifies the current location, orientation and any relevant information 80 and send it to the parking management application. The verification method may be a visual verification of the real-world rendered by an imaging sensor such as camera 108 embedded in the parking enforcement device. Referring back to FIG. 9 there are three parking lots defined with their location as part of the portal settings P1 100, P2 101 and P3 102 where that there are two parking vehicles, first vehicle 103 is parking legally in Pl, so there is a valid unstopped parking transaction associated with this parking lot. The second vehicle 104 is parking illegally in P2, so there is no valid unstopped parking transaction associated with this parking lot. Back to the method described in FIG. 7, as the verification method is based on the visual verification of the parked vehicles within the visual line-of-sight, the parking management program and algorithms 23 identifies the set of parking lots P1 100, P2 101 and P3 102 accessible 81 from the current location of the parking enforcement device and within the visual line-of-sight of the camera 108 embedded in the parking enforcement device 105. As the live video stream is rendered on the display, computer vision algorithms and other algorithms may be used to integrate the parking status 83 for every specific parking lot, namely, P1 100, P2 101 and P3 102 with the live video stream so text, graphics, video and audio can be superimposed into the live video stream. Referring back to FIG. 9, checking the parking status for P1 100 will result in a valid parking session, that will be rendered as graphics superimposed 107 into the live video stream, whereas checking for parking status for P2 101 will result in an invalid parking session, that may be rendered as a different graphics superimposed 106 into the live video stream, so the parking officer can quickly check 85 if a vehicle is parking in a parking lot with no valid parking transaction and trigger the parking violation sequence 86 if required.

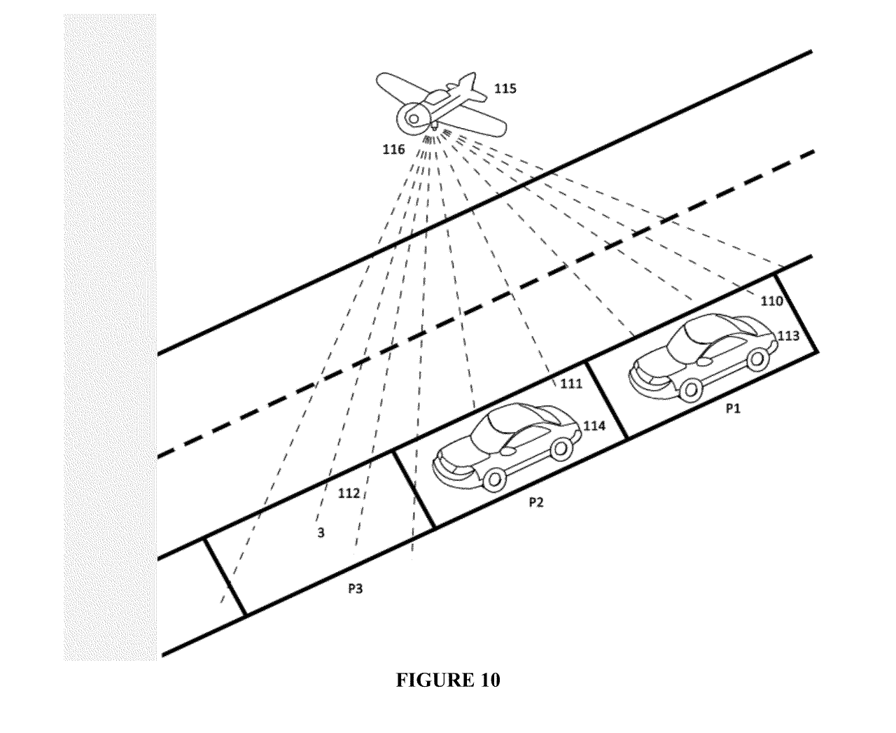

FIG. 10 shows an embodiment of the method described in FIG. 7 where the parking enforcement device 11 is mounted on an aerial vehicle. Turning back to method described in FIG. 7, the parking enforcement device that may include sensors such as a global positioning system (GPS) 13, and additional sensors such as accelerometer detecting the orientation of the device, compass detecting the device's orientation relative to that magnetic field and more 14 identifies the current location, orientation and any relevant information 80 and send it to the parking management application. The verification method may be an automated machine-based verification of the image rendered by imaging sensor such as camera 116 embedded in the parking enforcement device. Referring once again to FIG. 10 there are three Parking Lots defined with their location as part of the Portal settings P1 110, P2 111 and P3 112 where that there are two parking vehicles, first vehicle 113 is parking legally in P1, so there is a valid unstopped parking transaction associated with this parking lot. The second vehicle 114 is parking illegally in P2, so there is no valid unstopped parking transaction associated with this parking lot. Referring back to the method described in FIG. 7, the verification method may be an automated machine-based verification of the image generated by an imaging sensor such as camera 116 or other types of sensors, such as radars or laser based sensors deciding based on a signal reflected from the vehicle whether a vehicle is parking at the specific parking log. The parking management program and algorithms 23 identify the set of parking lots P1 110, P2 111 and P3 112 accessible 81 from the current location of the parking enforcement device and within the visual line-of-sight of the imaging sensor embedded in the parking enforcement device 116. Using the location information and the information from the other sensors, various algorithms may be used to transform the location of every parking lot as stored in the database 31 accessible from the current location of the parking enforcement device to a specific region on the generated image, that may represented as a polygon or any other geometrical shape with specific coordinates, on the image or on the sequence of images generated from the imaging sensor 116. As an example and referring back to FIG. 10, the imaging sensor 116 at the specific location of the aerial vehicle might generate an image with specific height and width, at the specific location and orientation and any other relevant parameters of the imaging sensor 116 the image of P1 110 might be represented on the same generated image as a rectangle with the top-left corner at point (x1,y1) at the bottom-right corner at point (x2,y2) on the generated image, where the sub-image with the coordinates of this rectangle (x1,y1)-(x2,y2) shows parking lot P1 110 and any vehicle that may or may not park at P1 110 at the time that the image was generated, so various image processing, machine vision and pattern recognition algorithms may be used to analyze this specific region on the image to determine whether a vehicle is parking or not at this specific region. Referring back to FIG. 7, and checking the parking status 83 for parking lot P1 110 will result in a valid parking transaction 84 but checking for the parking status 83 for P2 111 will not find a valid unstopped parking transaction 84 so applying the verification method 85 as described previously may identify a vehicle 114 parking in Parking Lot P2 111 and trigger the parking violation sequence 86. In one embodiment once the parking violation sequence starts, the parking officer may get a notification to his mobile device to approach Parking Lot P2 to confirm that the vehicle is parking illegally and issue a parking ticket or a fine if required. As the parking officer is guided directly to a specific parking lot this method is more efficient than the traditional method where the parking officer needs to approach every vehicle and check whether the vehicle is parking legally or not.

In one embodiment a municipality may allow external users 4 from other municipalities that are using the parking management system 30 to park in the parking lots managed by the same municipality, where users from different cities or even different countries may use the same parking management system 30 as they travel outside of their municipality.

In one embodiment the information managed by the parking management system 30, such as the location of the parking lots and the parking transactions and any other relevant information, may be used by various applications to provide additional services and functionality, where one such application may search for the closest available parking lot either from the current location of the mobile device 5 or from any target location specified by the user. As the external user 4 looks for a vacant parking lot, the mobile device 5 identifies the current location, sends it to the parking management application where the parking management program and algorithms 20 finds the closest parking lot with no valid parking transaction associated with it and communicate back to the user via the user interface 6. In other embodiments, other parameters such as cost, parking policies and more may be incorporated as input to the algorithms.

What is claimed is:

1. A method for location based vehicle parking management and parking fee payment enforcement, comprising the steps of:
a) storing all vehicle parking lot locations for a given geographic region into a database;
b) retrieving a current location and sensor data associated with a parking enforcement device;
c) sending said current location and said sensor data to a parking management program wherein said parking management program utilizes one or more verification methods;
d) creating a set of accessible vehicle parking lot locations from said database using said parking management program for a current location given by said parking enforcement device;
e) determining from said set of accessible vehicle parking lots a specific vehicle parking lot and checking whether said database contains a valid unstopped parking transaction for said specific vehicle parking lots;
f) determining that if a valid unstopped parking transaction is found then said parking management program status checks a next parking lot and if a valid unstopped parking transaction is not found, determining whether there is a vehicle parked at that specific parking lot using one or more verification methods and if a vehicle is found using said one or more verification methods in that specific parking lot then said parking management program triggers a parking violation sequence;
g) determining that if a valid unstopped parking transaction is not found, then said parking management program triggers a parking violation sequence, including issuing a parking fine; and
h) determining that if no more parking lots are available from said current location, moving said parking enforcement device to a next physical location and repeating steps a through I for this new location.

2. The method according to claim 1 wherein the step using one or more said verification methods, said verification is by a human-based visual verification process.

3. The method according to claim 1, wherein the step using one or more said verification methods, said verification is by applying image processing and machine learning algorithms on aerial imagery.

4. The method according to claim 1, wherein the step using one or more said verification methods, said verification is based on signal sent and returned from a vehicle using a radar signal.

5. The method according to claim 1, wherein the step using one or more said verification methods, said verification is based on signal sent and returned from a vehicle using a laser beam.

6. The method according to claim 1, wherein the step of retrieving sensor data is by using a mobile phone.

7. The method according to claim 1, wherein the step of retrieving said current location is by using GPS technology.

8. A location based vehicle parking management and parking fee payment enforcement system comprising:
at least one computer server connected through one or more portals to the World Wide Web global computer network, and said at least one computer server including a parking management system and database and a plurality of web-based software applications communicating with said parking management system and database, wherein said plurality of web-based software applications may connect said one or more portals to either an external user interface; a system administrator interface, a portal administrator interface, a parking officer interface and a municipality interface that are accessible using computer devices connected to the World Wide Web global computer network;
said parking management system being structured and disposed for collecting and managing different global settings of the parking management system by a system administrator and storing said global settings on said system database, including said system administrator creating, deleting and suspending specific portals, generate global reports aggregating information across multiple municipalities and set and modify parking policies and parking rates;
said parking management system being structured and disposed for collecting and managing different settings of said parking management system by a portal administrator and storing said settings on said system database, including said portal administrator managing different settings of said system specific to one or more municipalities and said one or more portals, set and update parking lot locations, set and modify different parking policies and parking rates, set and modify different payment options and set and modify any other relevant settings;
said parking management system being structured and disposed for collecting and managing different settings of said parking management system by internal municipality users and storing said settings on said system database, including said internal municipality users managing the on-going operation of said parking management system in accordance with said system administrator settings;
said parking management system being structured and disposed for collecting and managing different settings of said parking management system by external users and storing said settings on said system database, including said external users may in accordance with said system administrator settings create and update their user information such as first name, last name, home address, phone number and update various billing information such as a credit card number, PayPal account and may update various vehicle details like vehicle type, manufacturer, license plate number;
said parking management system being structured and disposed for collecting and managing different settings of said parking management system by a parking officer and storing said settings on said system database, including said parking officer checking for parking violations as part of the on-going operation of said parking management system;
said parking management system stores all vehicle parking lot locations for a given geographic region into a database;
said parking management system retrieves a current location and sensor data associated with a parking enforcement device;
said parking management system sends said current location and said sensor data to a parking management application wherein said parking management application utilizes one or more verification methods;
said parking management system creates a set of accessible vehicle parking lot locations from said database using said parking management application for a current location given by said parking enforcement device;
said parking management system determines from said set of accessible vehicle parking lots a specific vehicle parking lot and checks whether said database contains a valid unstopped parking transaction for said specific vehicle parking lot;
said parking management system determines that if a valid unstopped parking transaction is found then said parking management application status checks a next parking lot and if a valid unstopped parking transaction is not found, determining whether there is a vehicle parked at that specific parking lot using one or more verification methods and if a vehicle is found using said one or more verification methods in that specific parking lot then said parking management application triggers a parking violation sequence;
said parking management system determines that if a valid unstopped parking transaction is not found, then said parking management application triggers a parking violation sequence, including issuing a parking fine; and
said parking management system determines that if no more parking lots are available from said current location, said parking enforcement device is moved to a next physical location.

9. The system according to claim 8, wherein a verification method is performed using a human-based visual verification process.

10. The system according to claim 8, wherein a verification method is performed by applying image processing and machine learning algorithms on aerial imagery.

11. The system according to claim 8, wherein a verification method is based on a signal sent and returned from a vehicle using a radar signal.

12. The system according to claim 8, wherein a verification method is based on a signal sent and returned from a vehicle using a laser beam.

13. The system according to claim 8, wherein said current location and said sensor data is provided using a mobile phone.

14. The system according to claim 8, wherein said current location is found by using a cell tower triangulation signal.

15. The system according to claim 8, wherein said current location is found by using WiFi networks.

16. A location based vehicle parking management and parking fee payment enforcement system comprising:
a parking management program stores all vehicle parking lot locations for a given geographic region into a database;
said parking management program retrieves a current location and sensor data associated with a parking enforcement device;
said parking management program sends said current location and said sensor data to a parking management application wherein said parking management program utilizes one or more verification methods;
said parking management program creates a set of accessible vehicle parking lot locations from said database using said parking manage program for a current location given by said parking enforcement device;
said parking management program determines from said set of accessible vehicle parking lots a specific vehicle parking lot and checks whether said database contains a valid unstopped parking transaction for said specific vehicle parking lots;
said parking management program determines that if a valid unstopped parking transaction is found then said parking management program status checks a next parking lot and if a valid unstopped parking transaction is not found, determining whether there is a vehicle parked at that specific parking lot using one or more verification methods and if a vehicle is found using said one or more verification methods in that specific parking lot then said parking management program triggers a parking violation sequence;
said parking management program determines that if a valid unstopped parking transaction is not found, then said parking management program triggers a parking violation sequence, including issuing a parking fine; and
said parking management program determines that if no more parking lots are available from said current location, said parking enforcement device is moved to a next physical location.

17. The system according to claim 15, wherein a verification method is performed using a human-based visual verification process.

18. The system according to claim 15, wherein a verification method is performed by applying image processing and machine learning algorithms on aerial imagery.

19. The system according to claim 15, wherein a verification method is based on a signal sent and returned from a vehicle using a radar signal.

20. The system according to claim 15, wherein a verification method is based on a signal sent and returned from a vehicle using a laser beam.
